(19) United States
(12) Patent Application Publication
(10) Pub. No.: US 2021/0122388 A1
(43) Pub. Date: Apr. 29, 2021

(54) VEHICLE DISPLAY ENHANCEMENT

(71) Applicant: Ford Global Technologies, LLC, Dearborn, MI (US)

(72) Inventors: Shiqi Qiu, Canton, MI (US); Nithya Somanath, Farmington Hills, MI (US); Erick Michael Lavoie, Van Buren Charter Township, MI (US); Johannes Kristinsson, Ann Arbor, MI (US)

(73) Assignee: Ford Global Technologies, LLC, Dearborn, MI (US)

(21) Appl. No.: 16/661,280

(22) Filed: Oct. 23, 2019

(51) Int. Cl. B60W 50/14; B60W 40/08; B60W 40/10

(52) U.S. Cl. CPC B60W 50/14; G02B 2027/0196; B60W 40/10; B60W 40/08

(57) ABSTRACT

This disclosure describes systems, methods, and devices related to vehicle display enhancement. For example, a vehicle may receive data associated with a user of a vehicle, wherein the data is associated with eyewear worn by the user or information associated with a user profile. The device may identify a first object in a field of vision of the user while the user is situated in the vehicle. The device may apply first enhancement to the first object based on the data. The device may display the first enhancement on a display device of the vehicle.

### TECHNICAL FIELD

This disclosure generally relates to systems, methods, and devices of vehicles, and more particularly, to vehicle display enhancement.

### BACKGROUND

Generally, vehicle drivers face situations that may require them to make assessment of objects encountered while driving. Even in optimal environments, such as clear vision, daylight, or clear traffic signs, a driver may still need additional data that may assist in making a quick assessment. Further, a driver may not be driving in an optimal environment, may be using lenses or eyewear that may impact the lights received from objects in a line of vision, or may have a color vision deficiency. For example, a driver may be using eyewear with a certain color tint that may alter the color of objects encountered during driving.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a diagram illustrating an example environment for techniques and structures, in accordance with one or more example embodiments of the present disclosure.

FIG. 2 depicts an illustrative schematic diagram of a vehicle display enhancement system, in accordance with one or more example embodiments of the present disclosure.

FIG. 3 depicts a flow diagram of an illustrative process for a vehicle display enhancement system, in accordance with one or more example embodiments of the disclosure.

### DETAILED DESCRIPTION

Example embodiments described herein provide certain systems, methods, and devices, for vehicle display enhancement.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

### Overview

The systems, devices, and methods disclosed herein are configured to facilitate a vehicle display enhancement in a vehicle. In some embodiments, the systems, devices, and methods herein can be configured to provide mechanisms for enhancing a vehicle operator's experience by providing and activating remediating actions to enhance the driving environment in response thereto.

Generally, drivers encounter situations during driving that may require them to quickly assess how to handle them. Even in optimal environments, such as clear vision, daylight, or clear traffic signs, a driver may still need additional data that could assist in making a quick assessment. However, a driver may not be driving in an optimal environment, may be using lenses or eyewear that may impact the lights received from objects in a line of vision. For example, a driver may be using eyewear that have a certain color tint which may alter the color of objects encountered during driving. In some other examples, a driver may have color vision deficiency which may present challenges in identifying colored traffic signs or other signs on the road.

In the case of colorblind individuals, they may experience degraded visual images, where these images depend on color as a differentiating factor. For example in color vision deficiency (CVD) some of the challenges include identifying a red light, which may not be contrasted enough for the colorblind driver to spot the red light. The same issue may also depend on the color deficiency of the driver especially when the distance to the colored object is undetermined. In those situations it may be difficult to differentiate between two colors resulting in decreased driving experience. For example, in some other situations if a user cannot differentiate between green or red colors, a driver may assume a red light is a green light. The most common form of CVD is red-green, but drivers may also experience purple-blue color blindness. There are products such as glasses and contact lenses that provide some compensation for color-blindness. However, even though drivers may be able to purchase color corrective lenses to compensate for CVD, these solutions may be expensive, inconvenient, misplaced, or damaged. In order to alleviate such issues, the augmented reality (AR) head up display (HUD) technology (e.g., AR windshield, panoramic display, or any other display with AR functionality) could be leveraged to compensate for CVD without additional cost to the AR HUD and could adapt to different occupants with different needs.

Generally, a vehicle comprises one or more sensors and/or one or more cameras that are configured to capture objects and associated information based on certain criteria associated with the vehicle and a user of the vehicle such as a driver or passenger. Moreover, some embodiments include sensors that are capable of providing signals or output that can be analyzed to determine situational or contextual information. Examples of situational or contextual information include a type of eyewear and/or driver condition that may require certain adjustments and/or corrections in order to provide for a better user experience while operating the vehicle or other similar situational or contextual information. Thus, while the determination of the type of eyewear and/or driver condition can be determined, processed, and certain features of a display is augmented and displayed to the driver in a visual format, additional situational or contextual information can also be displayed, thus creating an enhanced display.

An enhanced display of the present disclosure can include one or more visual indicators, where each visual indicator provides at least one aspect of calibrated or augmented information. Collectively, the one or more visual indicators provide the driver with an enhanced display or a view associated with objects appearing in the field of vision of the driver. The visual indicators include at least one physical indicator such as light emitting elements, steering wheel vibration, seat vibration, or audible signals or tones associated with the context and/or verbal cues (e.g., “red light ahead”). The one or more indicators include at least one graphical user interface or virtual element displayed or projected onto an optical surface, such as overlaying identified objects in the line of vision with additional indicia to enhance the display. The one or more visual indicators include combinations of both physical and/or virtual elements. According to some embodiments, some of the one or more visual indicators used in a display can have at least one visual attribute adjusted on a dynamic or real-time basis in response to the type of eyewear and/or driver condition or contextual information determined.

### Illustrative Embodiments

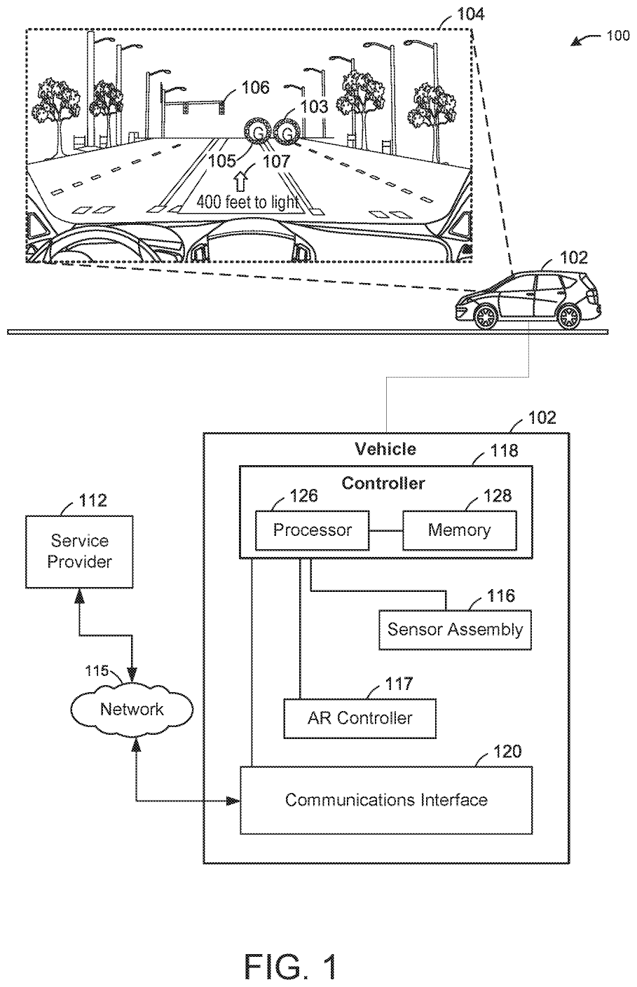

Turning now to the drawings, FIG. 1 depicts an illustrative architecture 100 in which techniques and structures of the present disclosure may be implemented.

The illustrative architecture 100 may include a vehicle 102, an optical surface 104, and one or more objects, such as object 106. In general, the object 106 could include a stoplight that may be encountered during driving the vehicle 102. Other objects can likewise be identified and enhanced as disclosed herein.

The optical surface 104 could be a head up display (HUD), a portion of windshield, or any other area that could incorporate one or more enhancements, such as enhancements 103, 105, and 107, as disclosed in the present disclosure. The one or more enhancements could be incorporated to assist the driver based on one or more determined characteristics of the driver or eyewear worn by the driver.

Components of the architecture 100, such as the vehicle 102 may be connected to a network 115 that allows the vehicle 102 to communicate with external services (e.g., service provider 112). In some examples, the service provider 112, may comprise a database containing information associated with one or more objects identified by one or more components of the vehicle 102 and/or one or more types of eyewear used by the driver. It should be understood that a database of the one or more types of eyewear or additional indicia associated with the one or more enhancements may also be locally stored in the vehicle 102.

The network 115 may include any one or a combination of multiple different types of networks, such as cable networks, the Internet, wireless networks, and other private and/or public networks. In some instances, the network 115 may include cellular, Wi-Fi, or Wi-Fi direct.

In general, the vehicle 102 can comprise any vehicle that may comprise a controller 118, a sensor assembly 116, an augmented reality (AR) controller 117, and a communications interface 120 (an optional feature for some embodiments).

In various embodiments, the optical surface 104 includes a front or rear windshield of the vehicle 102. For purposes of brevity and clarity, examples provided herein may reference the optical surface 104 as a HUD or the front windshield of the vehicle 102. The optical surface can include other surfaces within the vehicle 102.

In some embodiments, the controller 118 may comprise a processor 126 and memory 128. The memory 128 stores instructions that are executed by the processor 126 to perform aspects of the one or more techniques and structures disclosed herein. When referring to operations executed by the controller 118 it will be understood that this includes the execution of instructions by the processor 126.

In some embodiments, the sensor assembly 116 may comprise one more sensors capable of capturing data received from objects within the range of the one or more sensors. For example, an image captured by the sensor assembly 116 may include the object 106 or details associated with the driver, such as eyewear, or other characteristics associated with the driver.

In some embodiments, the sensor assembly 116 could comprise any of a camera, a time-of-flight (TOF) camera, light detection and ranging (LIDAR), or other similar systems which may be utilized to recognize and capture data associated with objects and/or a driver of the vehicle 102.

In other embodiments, the sensor assembly 116 can capture data in order to facilitate calibration of the one or more enhancements based on the captured data. For example, if the sensor assembly 116 determines that a driver's eyewear is of a certain type, the sensor assembly 116 may transmit this data to the controller 118 in order to perform calibration such that the one or more enhancements are based on the calibration.

The AR controller 117 may facilitate processing data captured by the sensor assembly 116 in order to enhance one or more displays such as the optical surface 104 by presenting the one or more enhancements to the driver of the vehicle 102. The AR controller 117 may access an AR display to present the one or more enhancements.

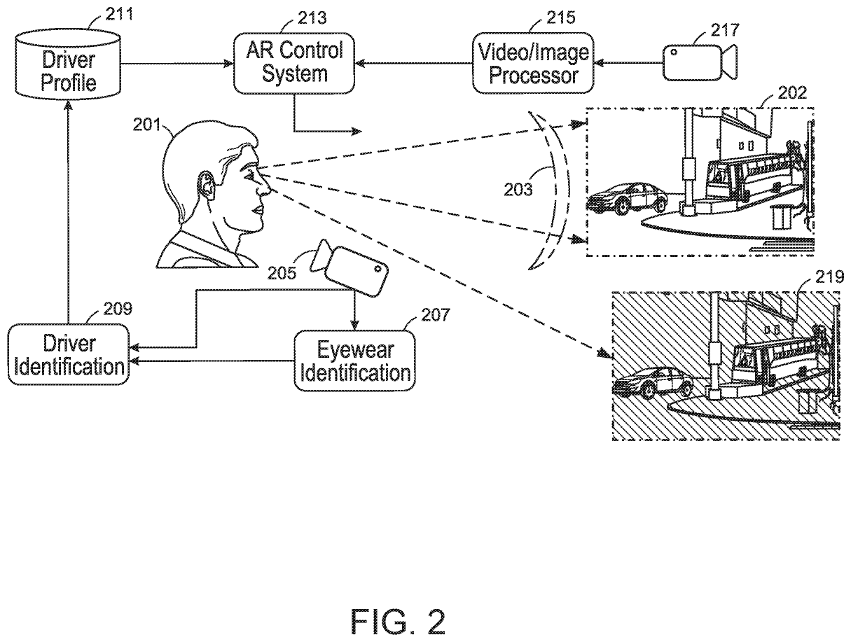

FIG. 2 depicts an illustrative schematic diagram of a vehicle display enhancement system, in accordance with one or more example embodiments of the present disclosure.

Referring to FIG. 2, there is shown a user 201 of a vehicle (e.g., vehicle 102 of FIG. 1) that may be interacting with an environment or otherwise an area of interest 202. The user 201 may be a driver or a passenger of the vehicle. The user 201 may benefit from one or more enhancements that may be interjected in the line of sight between the user 201 and the area of interest 202. The line of sight between the user 201 and the area of interest 202 may be visible through a display 203. The display 203 may comprise a head up display (HUD) projected on a windshield, a portion of the windshield, an AR display, or any other displays that may be capable of presenting the one or more enhancements. FIG. 2 further shows a sensor 205, a driver profile 211, an AR control system 213, a video/image processor 215, and a sensor 217.

The sensor 205 that may be directed to capture characteristics associated with the user 201. For example, the sensor 205 may comprise a camera to capture information associated with the objects used by the user 201, such objects may include eyewear, visors, helmets, or any other object that may be used to assist the user 201 in viewing the area of interest 202. In case the user 201 does not utilize the display 203, the user 201 may experience a degraded view as shown in area of interest 219 based on factors such as eyewear color spectrum, colorblindness, glare, or any other degrading factors that may impact the area of interest.

A vehicle display enhancement system may assist a user while driving a vehicle by adding enhancements to displays resulting in a better driving experience.

A vehicle display enhancement system may be configured to use AR to assist a user in distinguishing between different colors in areas of interest. A vehicle display enhancement system may evaluate one or more elements associated with the driver (e.g., eyewear, colorblindness, profile, etc.). The one or more elements may be data that is received in real-time or may be retrieved from a local or remote database. The vehicle display enhancement system may determine based on these one or more elements what type of correction is needed (e.g., color adjustments, additional indicators, emphasis of indicators, or any other enhancements to display features) in order to assist the driver in better identification of an object in a visual range. For example, a vehicle display enhancement system may perform color compensation and identification, such as highlighting, enhancing, or adding text to a portion of the display.

A vehicle display enhancement system may be configured to overlay items in the real world so that they become more enhanced and more useful to the driver. For example the vehicle display enhancement system may be configured to enhance an identified eyewear by intensifying a light wavelength based on the type of eyewear. For example, the vehicle display enhancement system may overlay a red color with a certain wavelength such that the user is able to see a better color based on the condition that is placed in front of the user (e.g., certain colorblindness, using a certain type of eyewear that may affect the color being projected to the user.

A database that contains information about certain types of eyewear may be accessed in order to extract information associated with an eyewear to assist in the calibration of colors. However, if the eyewear is not listed in the database, a user may need to manually calibrate the vehicle display enhancement system to enhance user visual experience.

In some embodiments, a vehicle display enhancement system may be configured to add light to the field of vision, while the eyewear may be blocking or filtering the field of vision. That is, the vehicle display enhancement system may add an overlay in the view of the driver such that the driver is able to view enhanced objects in the field of vision. For example, in cases where glasses block blue light, the vehicle display enhancement system may enhance certain wavelength of light to correspond and adjust to the vision of the driver.

A vehicle display enhancement system may use in-vehicle AR technology to enhance the driving experience for colorblind driver and aid in safe driving. For example a vehicle display enhancement system may utilize the in-vehicle sensors and AR hardware (e.g., AR control system 213) to help CVD drivers. In some embodiments, the vehicle display enhancement system may provide a novel CVD compensation system integrated into the AR HUD and/or windshield in order to assist the driver in distinguishing between potentially confusing colored elements in the environment while reducing distractions.

A vehicle display enhancement system may be configured to perform one or more steps to assist the driver. For example, the vehicle display enhancement system may perform eyewear identification 207 and/or driver identification 209.

The vehicle display enhancement system may determine a driver profile 211 based on the driver identification 209. The driver profile 211 may be then inputted into the AR control system 213 in order to introduce enhancements based on the images captured by sensor 217 that are processed by a video/image processor 215.

Further, the vehicle display enhancement system may perform color calibration (e.g., change color, brightness, size, shade of AR element to adapt to the driver). The vehicle display enhancement system may also perform critical object detection, critical object color compensation/identification using, for example an AR control system 213. Examples of critical object color compensation/identification may be implemented for traffic lights, traffic signs, or any other traffic related signals. The vehicle display enhancement system may enhance the environment in the field of vision of the driver by performing color compensation and by performing adaptation to types of scenes such as a fall foliage or a city environment.

A vehicle display enhancement system may utilize an interior sensor (e.g., sensor 205), when available, such as a camera in order to identify whether the driver is wearing a type of eyewear or a lens to compensate for CVD. In case an interior sensor is unavailable, a vehicle display enhancement system may be configured to determine based on input from the driver whether the driver is wearing an eyewear or a lens to compensate for CVD. If an interior sensor is available such as a camera, the system applies a learning algorithm to identify the lens and automatically detect if it is worn in the future. In turn, a vehicle display enhancement system may be configured to use this information to determine how to adapt the display (e.g., AR HUD output) to provide an intuitive, consistent visual experience across various types of lens use. For example, the AR HUD may modify color wavelength, luminosity, saturation and other display properties to accomplish this. In order to further optimize the AR HUD performance for various users, the system may provide the driver with a display color calibration process that performs one or more functions. The one or more functions may comprise: 1) inviting the driver to begin the calibration the first time a driver with unknown CVD uses the vehicle; 2) inviting the driver to begin the calibration the first time a type of sunglasses are detected; 3) inviting the driver to begin the calibration if the vehicle is stationary and if the system previously identified a failure of the driver to react appropriately to a color; 4) inviting the driver to access a variety of user interfaces, such as a menu or voice command; 5) using the AR HUD to display a set of colored elements such as traffic lights where the color has been compensated for a particular form of CVD; 6) asking the driver to select the easiest color calibration to use.

A vehicle display enhancement system may facilitate critical object color compensation/identification and environmental adaptation. For example, it may be beneficial for the AR HUD to adapt the scope of the CVD compensation for the environment. Therefore the system may use location, season, and/or weather information to adapt where to apply the compensation within view of the driver. For example, if the vehicle is in a location where there is significant vehicle and pedestrian traffic, it may be beneficial to apply AR HUD compensation to particular elements in the scene to which the driver needs to respond such as traffic lights, signs, bike reflectors, construction barrels, orange vests, or other elements in the path of the vehicle. The vehicle display enhancement system may identify color elements of interest in the environment and their locations relative to the driver and vehicle. The vehicle may apply sensor fusion, artificial intelligence, machine learning and other techniques to process signals from the perception sensors such as camera, RADAR, LiDAR and the like.

The vehicle display enhancement system may compensate color elements in the environment for CVD to which the driver needs to respond by providing a color overlay designed to help the driver identify the color.

Additional information may be added to the display such as additional colored elements, shapes, and/or text. For example, the AR HUD may display a CVD color compensated stop sign if a stop sign is detected. Another example, the AR HUD may display a construction zone speed limit with CVD color compensated overlays on construction zone elements such as barrels, vests, or any other construction zone related objects.

A vehicle display enhancement system may use vehicle inertial sensing, steering wheel angle, wheel speed sensors and the like to predict a path and provide an AR HUD color overlay on the area of the display in the line of sight of the vehicle path.

A vehicle display enhancement system may facilitate full view environmental color adaptation. For example, there may be scenarios where it would be desirable to color correct the entire scene for CVD such as when the vehicle is driven in a scenic area where the driver would like to have a better view of the entire environment. For example, the driver may be using the vehicle for a road trip to view vegetation blooming in the spring or leaves changing color in the fall, etc. Additionally, the AR HUD may provide CVD color overlay compensation that adapts to the drivers eyewear, light properties of objects, properties of ambient light, angle of sunlight or other light sources, etc. For example the AR HUD may adjust color wavelength, saturation, luminosity and the like as a function of: 1) tinted lenses; 2) reflectivity of objects; 3) color temperature of ambient light; and 4) location of sun using location and time.

There may be various benefits to implementing a vehicle display enhancement system. Some of these benefits may include assisting a driver in identifying and acting to the traffic lights/signs status earlier and easier; improving the driving experience of colorblind drivers in all conditions (day/night, all weathers, all environment; decreasing chances of violating driving rules; and providing an easy way to identify a traffic light from other lights (e.g., vehicle lights or street lights) around at night. It is understood that the above descriptions are for purposes of illustration and are not meant to be limiting.

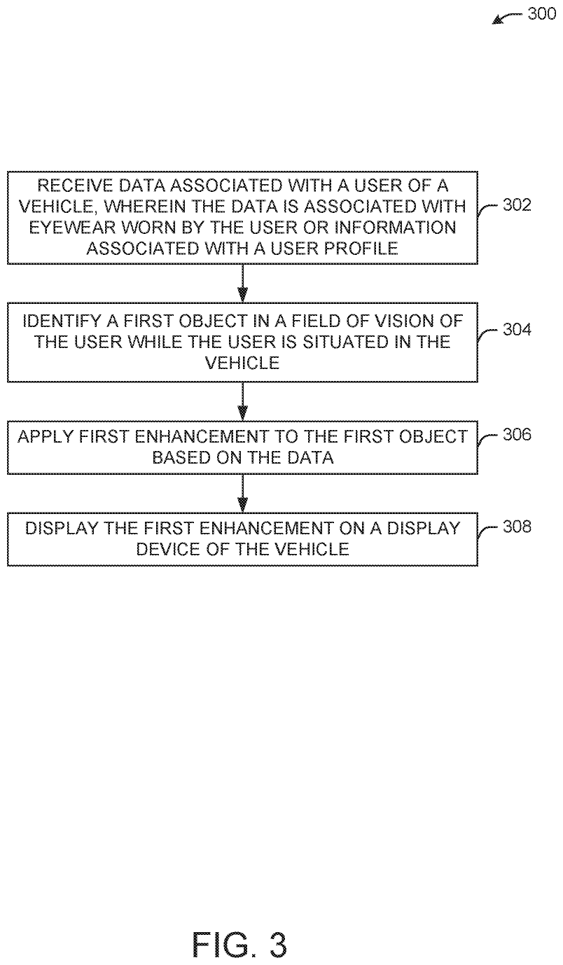

FIG. 3 illustrates a flow diagram of illustrative process 300 for an illustrative vehicle display enhancement system, in accordance with one or more example embodiments of the present disclosure.

The following illustrative process 300 is exemplary but not confined the actual steps; and moreover, alternative embodiments may include more or less steps that are shown or described herein.

At block 302, a vehicle (e.g., the vehicle 102 of FIG. 1) may receive data associated with a user (e.g., a driver or a passenger) of the vehicle. The data may be received from a first sensor of the vehicle. In some examples, the first sensor is configured to capture the data within an interior of the vehicle. The data may include identification information of an eyewear associated with the user and/or may include a user profile associated with the driver of the vehicle. For example, a driver identification system may identify the driver (or driver identifies himself through human machine interface (HMI)), driver profile with colorblindness information provided to the AR control system. In some other examples, an eyewear identification system may identify the eyewear used by the driver (or the driver may identify his or her eyewear condition through HMI). The AR control system may compensate for the eyewear. Further, the driver profile may be shared between vehicles. For example, the user profile used in a first vehicle can be transferred to a second vehicle.

At block 304, the vehicle may identify one or more objects in a field of vision of the user. In some examples, the one or more objects are identified using a second sensor of the vehicle, where the second sensor is associated with capturing data from an exterior of the vehicle.

At block 306, the vehicle may apply one or more enhancements to the one or more objects based on the data. In some embodiments, an augmented reality (AR) control system may calibrate the display device based on the received data and the one or more objects. The one or more enhancements include color compensation, visual indicators, or physical indicators. For example, an AR control system may calibrate the display color of AR elements based on driver condition (e.g., avoid unrecognized color, enhance certain color scheme), eyewear, AR HUD/windshield glass if tinted.

At block 308, the vehicle may display the one or more enhancements on a display device of the vehicle. For example when important traffic signs/signals recognized by a critical object detection system, the vehicle may highlight/indicate the signs/signals with AR elements, such as a stop sign, a warning sign, a traffic light status, and other indications. It is understood that the above descriptions are for purposes of illustration and are not meant to be limiting.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method comprising:
receiving, by a processor, data associated with a user of a vehicle, wherein the data is associated with eyewear worn by the user or information associated with a user profile;
identifying a first object in a field of vision of the user while the user is situated in the vehicle;
applying first enhancement to the first object based on the data; and
displaying the first enhancement on a display device of the vehicle.

2. The method of claim 1, wherein the data is received from a first sensor of the vehicle.

3. The method of claim 2, wherein the first sensor is configured to capture the data within an interior of the vehicle.

4. The method of claim 1, wherein the first object is identified using a second sensor of the vehicle, wherein the second sensor is associated with capturing data from an exterior of the vehicle.

5. The method of claim 1, further comprising calibrating the display device based on the received data and the first object.

6. The method of claim 1, wherein the first enhancement include color compensation, visual indicators, audible indicators, or physical indicators.

7. The method of claim 1, wherein applying the first enhancement comprises adjusting a color wavelength, a color saturation, or a color luminosity.

8. The method of claim 1, wherein the user profile is shared between vehicles.

9. A device comprising:
a processor; and
a memory for storing instructions, the processor is configured to execute the instructions to:
receive data associated with a user of a vehicle, wherein the data is associated with eyewear worn by the user or information associated with a user profile;
identify a first object in a field of vision of the user while the user is situated in the vehicle;
apply first enhancement to the first object based on the data; and
display the first enhancement on a display device of the vehicle.

10. The device of claim 9, wherein the data is received from a first sensor of the vehicle.

11. The device of claim 10, wherein the first sensor is configured to capture the data within an interior of the vehicle.

12. The device of claim 9, wherein the first object is identified using a second sensor of the vehicle, wherein the second sensor is associated with capturing data from an exterior of the vehicle.

13. The device of claim 1, wherein the processor is further configured to calibrate the display device based on the received data and the first object.

14. The device of claim 9, wherein the first enhancement include color compensation, visual indicators, audible indicators, or physical indicators.

15. The device of claim 9, wherein applying the first enhancement further comprises the processor being configured to adjust a color wavelength, a color saturation, or a color luminosity.

16. A system comprising:
a sensor assembly having a first sensor for driver identification and a second sensor for object identification, the sensor assembly being configured to:
receive data associated with a user of a vehicle, wherein the data is associated with eyewear worn by the user or information associated with a user profile; and
identify a first object in a field of vision of the user while the user is situated in the vehicle;
a controller assembly having a processor and memory, the processor being configured to execute instructions stored in the memory to:
apply first enhancement to the first object based on the data; and
display the first enhancement on a display device of the vehicle.

17. The system of claim 16, wherein the data is received from a first sensor of the vehicle.

18. The system of claim 16, wherein the first sensor is configured to capture the data within an interior of the vehicle.

19. The system of claim 16, further comprising the instructions to calibrate the display device based on the data received from the first sensor and the one or more objects.

20. The system of claim 16, wherein the first enhancement include color compensation, visual indicators, audible indicators, or physical indicators.
